(19) United States
(12) Patent Application Publication
(10) Pub. No.: US 2008/0080840 A1
(43) Pub. Date: Apr. 3, 2008

(54) MOVING DATA PROCESSING DEVICE, MOVING DATA PROCESSING METHOD, STORAGE MEDIUM, AND COMPUTER DATA SIGNAL

(75) Inventors: Yutaka EGAWA, Kawasaki-shi (JP); Michitoshi Suzuki, Kawasaki-shi (JP); Masakazu Ogawa, Kawasaki-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 11/742,943

(22) Filed: May 1, 2007

(30) Foreign Application Priority Data
Sep. 29, 2006 (JP) 2006-269068

(51) Int. Cl. H04N 5/91

(52) U.S. Cl. 386/96; 386/E05.001

(57) ABSTRACT

A moving data processing device that extracts plural portions of plural moving data items, which satisfy a given condition, connects the plural extracted portions to one another to thereby produce single-item partial moving data, and outputs the produced partial moving data.

### CROSS-REFERENCE TO RELATED APPLICATIONS

This application is based on and claims priority under 35 U.S.C. 119 from Japanese Patent Application No. 2006-269068 filed on Sep. 29, 2006.

### BACKGROUND

1. Technical Field

The present invention relates to a moving data processing device, a moving data processing method, a recording medium, and a computer data signal.

2. Related Art

There is available a device for summarizing and reproducing moving data such as motion image accompanied by audio, and so forth.

One of the objects of the present invention is to provide a moving data processing device capable of producing summaries of plural moving data items.

### SUMMARY

According to one aspect of the invention, there is provided a moving data processing device comprising an extraction device that extracts plural portions of plural moving data items, which satisfy a given condition, a production device that connects the plural portions extracted to one another to thereby produce single-item partial moving data, and an output device that outputs the produced partial moving data.

### BRIEF DESCRIPTION OF THE DRAWINGS

Exemplary embodiment(s) of the present invention will be described in detail based on the following figures, wherein:

FIG. 1 is a block diagram showing an example of a structure of a moving data processing device according to an exemplary embodiment of the present invention and the state of connection thereof;

FIG. 2 is a diagram showing an example of moving data held in the moving data processing device according to the exemplary embodiment of the present invention;

FIG. 3 is a functional block diagram showing one example of the moving data processing device according to the exemplary embodiment of the present invention;

FIG. 4 is a diagram showing an example of partial moving data produced by the moving data processing device according to the exemplary embodiment of the present invention;

FIG. 5 is a diagram showing an example of display of the partial moving data distributed from the moving data processing device according to the exemplary embodiment of the present invention;

FIG. 6 is a flowchart of an example of a process to be carried out by the moving data processing device according to the exemplary embodiment of the present invention;

FIG. 7 is a diagram showing another example of partial moving data produced by the moving data processing device according to the exemplary embodiment of the present invention; and

FIG. 8 is a diagram showing the outline of the operation of the moving data processing device according to the exemplary embodiment of the present invention.

### DETAILED DESCRIPTION

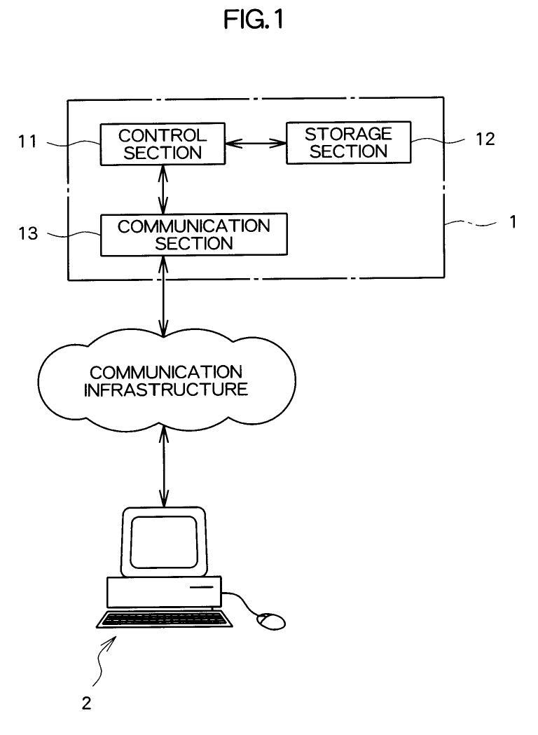

A moving data processing device 1 according to an exemplary embodiment of the present invention is constructed having a control section 11, a storage section 12, and a communication section 13, as shown in FIG. 1. The moving data processing device 1 is connected to a terminal device 2 via a communication infrastructure, such as electrical communication equipment, or the like.

The control section 11 is a program control device, such as a microprocessor, providing a function as a computer. The control section 11 in this exemplary embodiment extracts a portion of the moving data stored in the storage section 12, which satisfies a predetermined condition, and connects the extracted portions to one another to thereby produce a single item of moving data to output. Specific content of the process to be carried out by the control section 11 will be described later.

The storage section 12 includes a readable and writable storage element (Random Access Memory, and so forth) and a storage element dedicated to reading (Read Only Memory, and so forth). The storage section 12 stores a program to be executed by the control section 11. The storage section 12 also serves as a work memory, holding various kinds of information necessary in the operation by the control section 11, for example. The storage section 12 in this exemplary embodiment includes an information recording device, such as a hard disk device, or the like, for magnetically or optically recording information. The storage section 12 stores moving data to be processed by the control section 11.

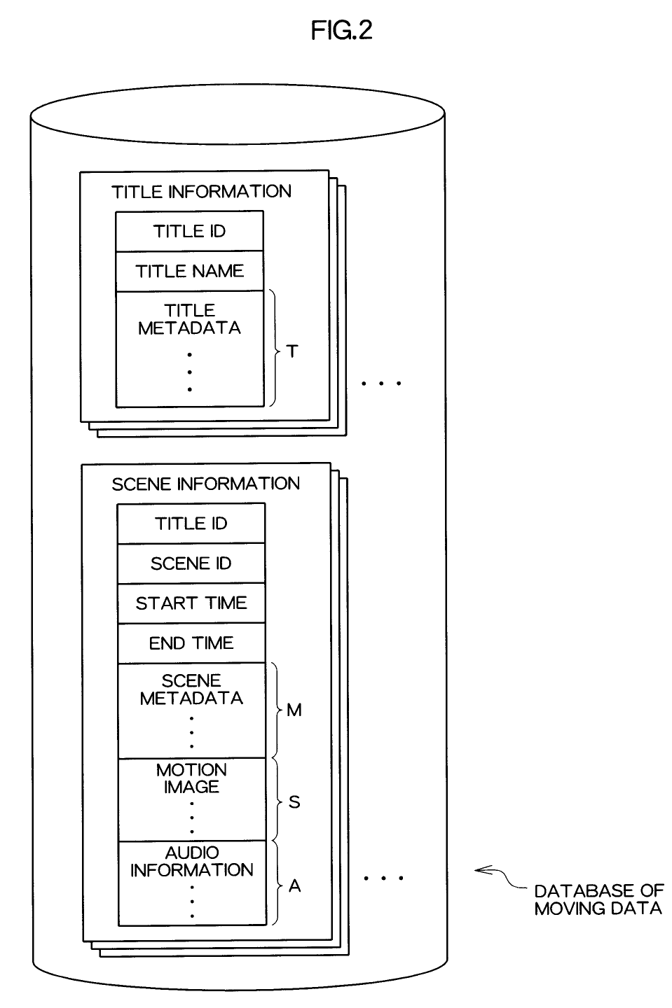

The moving data is data which varies as time passes (time-series data). A specific example of the moving data here may be motion image information. The motion image information here contains at least a single item of scene information, as shown in FIG. 2, and is associated with title information. The title information, for every item of motion image information, includes a unique title identifier (title ID), character string information (name) identifying the title, and title metadata (T). Each of the scene information items contains a title identifier (title ID) for associating the information item concerned with relevant title information. The scene information, for every scene, includes a unique scene identifier (scene ID), a period of time taken in reproduction from the head of the motion image information to the head of the scene concerned (a start time), a period of time taken in reproduction from the head of the motion image information to the end of the scene concerned (an end time), scene metadata (M) which contains a character string which is referred to in a search, a motion image contained in the scene concerned (S: a series of static images), and audio information (A) to be reproduced together with the motion image.

Here, the scene identifier may be a sequential number (a scene number) indicative of the order of reproduction of the scene concerned with the relevant title. When the scene identifier is not used as a scene number, a scene number may be contained in the scene information separately from the scene identifier.

A program to be executed by the control section 11 may be stored in a computer readable information recording medium, such as a CD-ROM, a DVD-ROM, and so forth, which magnetically or optically stores information. Alternatively, such a program may be copied, or the like, from such an information recording medium into the storage element described above, and stored therein.

The communication section 13 exchanges various kinds of information with respect to the terminal device 2 via communication equipment (communication infrastructure) with representative examples thereof being a network card or a modem. The communication section 13 outputs the information sent from the terminal device 2 to the control section 11. Also, according to an instruction sent from the control section 11, the communication section 13 sends the information to the terminal device 2.

The terminal device 2 is a computer system having an input/output device, such as a monitor, a keyboard, a mouse, and so forth, for example. Specifically, the terminal device 2 requests the moving data processing device 1 in this exemplary embodiment via a communication infrastructure to send motion image information, or moving data, then displays an image contained in the moving data sent from the moving data processing device 1 in response to the request, and reproduces the accompanying audio. Also, according to an instruction input by the user, the terminal device 2 instructs the moving data processing device 1 to retrieve a portion of the moving data, which satisfies the condition designated by the user.

In the following, a specific process to be carried out by the control section 11 of the moving data processing device 1 in the exemplary embodiment will be described.

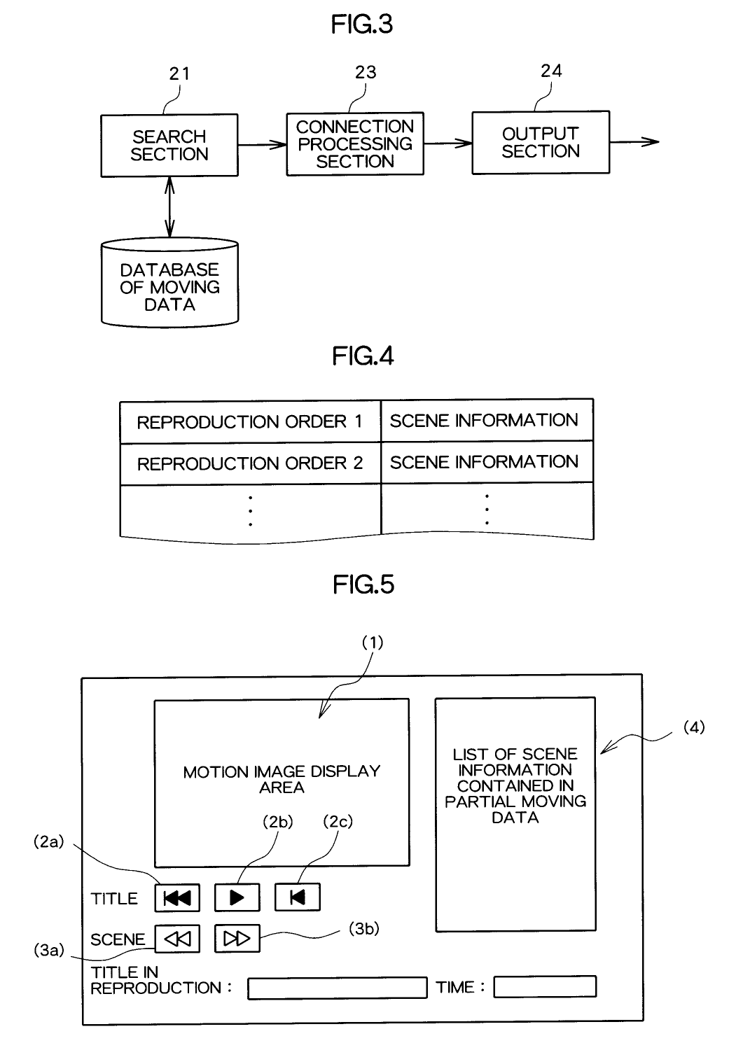

That is, the control section 11 executes a program stored in the storage section 12 to thereby realize, by means of software, the moving data processing device 1 in this exemplary embodiment. The moving data processing device 1 in this exemplary embodiment is constructed having, in terms of function, a search section 21, a connection processing section 23, and an output section 24, as shown in FIG. 3.

The search section 21 receives a condition to be used in a search for a portion of the moving data, sent from the terminal device 2. It should be noted that although it will be described here that the search condition is given in the form of a character string, this is not an exclusive example. The search section 21 searches for moving data, among the motion images stored in the storage section 12, which has scene metadata which contains a character string corresponding to the received search condition, then retrieves the moving data hit in the search, and outputs to the connection processing section 23.

The connection processing section 23 connects the moving data items retrieved by the search section 21 to thereby produce single-item moving data. The produced single-item moving data is hereinafter referred to as partial moving data. The output section 24 sends the partial moving data produced by the connection processing section 23 to the terminal device 2. Here, the partial moving data is information in which scene information items are listed in the order of connection, for example, as shown in FIG. 4.

Here, suppose that the control section 11 receives information which specifies a title identifier and also an instruction, from the terminal device 2, which requests reproduction of the title identified by the received title identifier. In this case, the control section 11 retrieves scene information items which contain that title identifier from the storage section 12, and distributes the retrieved scene information items in the order of scene numbers thereof to the terminal device 2 having instructed the reproduction.

With the above-described structure, in the system including the moving data processing device 1 in this exemplary embodiment, when the user of the terminal device 2 inputs the character string of a search condition in the terminal device 2, the search condition is sent to the moving data processing device 1, where a scene information item which has scene metadata which contains a character string corresponding to the search condition is searched for. The moving data processing device 1 then connects the motion images and audio information items contained in the scene information items obtained in the search to one another to thereby produce single-item moving data. Then, the resultant single-item moving data is distributed to the terminal device 2.

As one example, suppose that plural motion images of domestic animals are stored in the storage section 12 of the moving data processing device 1. Then, further suppose that the scene metadata in a certain scene information item (having a scene identifier “1”) contains information “Japanese dog, Japan terrier”; that of a screen information item having a scene identifier “2” contains “foreign dog, Irish setter”; and that of a scene information item having a scene identifier “3” contains information “cat, short hair, mongrel”. In the above, when the character string “Japan, dog” is given as a search condition, the control section 11 of the moving data processing device 1 searches for a scene information item which has scene metadata which contains “Japan” or “dog” among the above-described scene information item.

In addition, as a degree of relevance which indicates the extent of relevance between the search condition and a scene information item obtained in the search, the number of character string corresponding to the search condition and contained in the scene metadata is counted, and associated with the scene information item concerned.

In the example above, the degree of relevance of the scene identifier “1” is “3” (as there are three hits including two for Japan and one for dog), and that of the scene identifier “2” is “1”. As for the scene identifier “3”, the degree of relevance is not shown as the result of the search as the scene metadata contains neither “Japan” nor “dog”.

The control section 11 of the moving data processing device 1 combines the fragmented moving data of the scene identifier “1” and that of the scene identifier “2” to thereby produce a single-item moving data (or a partial moving data), and distributes the partial moving data to the terminal device 2.

In the above, it may be arranged such that the fragmented moving data relevant to each of the scene information items is displayed with the character string of the title (the title specified by the title identifier contained in the concerned scene information item) to which the scene information item concerned belongs, superimposed thereon. For this process, the character string of the associated title may be superimposed onto the motion image of each of the scene information items to be contained in the partial moving data, for example, so that the motion image subjected to the superimposition is distributed to the terminal device 2. Alternatively, the character string of the associated title may be associated with the motion image of each of the scene information items, and then sent to the terminal device 2, so that the terminal device 2 superimposes the character string of the title onto the motion image before display.

Not only the character string of the title but also other information, such as a start time and an end time, for example, contained in the scene information may also be included.

Also, the terminal device 2 may measure a reproduction time of each of the scene information items, and in response to a predetermined instruction from the user (which is carried out, for example, by pressing one of the buttons displayed on the screen), add the measured reproduction time to the reproduction start time, contained in the scene information item being currently reproduced, to thereby convert the reproduction time of the motion image being currently reproduced to a reproduction time within the concerned title.

Then, the information on the resultant reproduction time and the title identifier contained in the scene information item being currently reproduced are sent to the moving data processing device 1, and reproduction of the title identified by the title identifier, beginning with the point corresponding to the resultant reproduction time, may be instructed. With this arrangement, the user can begin reproduction of the title, beginning with the point the user currently views and listens to using the partial moving data.

Further, in response to the user instruction, the terminal device 2 sends the title identifier contained in the scene information item currently being reproduced to the moving data processing device 1, so that the moving data processing device 1 distributes the motion image of the title identified by the title identifier, beginning with the head thereof. Alternatively, the terminal device 2 may additionally send the information on the start time, contained in the scene information item, to the moving data processing device 1, so that the moving data processing device 1 distributes the motion image, beginning with that scene.

In the terminal device 2, a screen for showing the partial moving data contains the following items, as shown in FIG. 5: that is, (1) an area for showing the partial moving data, (2) a button for instructing reproduction of the title relevant to the motion image currently being reproduced as partial moving data (beginning with (2a) the head of the title, (2b) the point being currently reproduced, and (2c) the beginning of the scene being currently reproduced), (3) a button for instructing reproduction of (3a) the scene information item being currently reproduced, beginning with the head thereof, and (3b) the scene information item immediately following the scene information item being currently reproduced, beginning with the head thereof, and (4) a list of scene information items contained in the distributed partial moving data (for example, either the character string of a scene name, if any, contained in the scene information item, or at least a portion of the scene metadata), and so forth.

Here, when (3a) reproduction of the scene information item being currently reproduced, beginning with the head thereof, is instructed, the terminal device 2 begins reproduction of the moving data contained in the scene information item currently being reproduced, beginning with the head thereof.

Also, when (3b) reproduction of the scene information item immediately following the scene information item currently being reproduced, beginning with the head thereof, is instructed, the terminal device 2 begins reproduction of the moving data of the scene information item to be reproduced, according to the order of connection, immediately after the scene information item currently being reproduced, beginning with the head thereof.

It should be noted that although the order of connection of the scene information items is not particularly limited in the above, the items may be connected in order of the degree of relevance. Alternatively, the scene information items may be connected in order of the title identifiers, so that the motion images of the scene information items under the same title are successively reproduced. It should be noted that although the number of character string corresponding to a given search condition and contained in the scene metadata in each of the scene information items is used as the degree of relevance of that scene information item in the above, this is not an exclusive example. The information on the degree of relevance may be calculated based on not only scene metadata but also a scene length, the number of character strings corresponding to a given search condition and contained in the title metadata, a degree of significance defined in advance for every scene, or the like. Here, the control section 11 of the moving data processing device 1 may arrange so as not to include a scene information item having the degree of scene significance set at a predetermined value, such as “0”, in the partial moving data.

Alternatively, the order of connection may be given by the user. For example, in the case where the title identifier, as shown in FIG. 2, additionally contains a creator name, creation time and date, recording time and date, and so forth, and/or where the scene information further contains a character string as a scene name, the scene information items may be re-arranged in the order based on these items, and connected.

Further, in the case where the scene information items to be connected to one another are those which are to be successively reproduced during a relatively short period of time, such as those to be successively reproduced under one title, these scene information items may be connected successively.

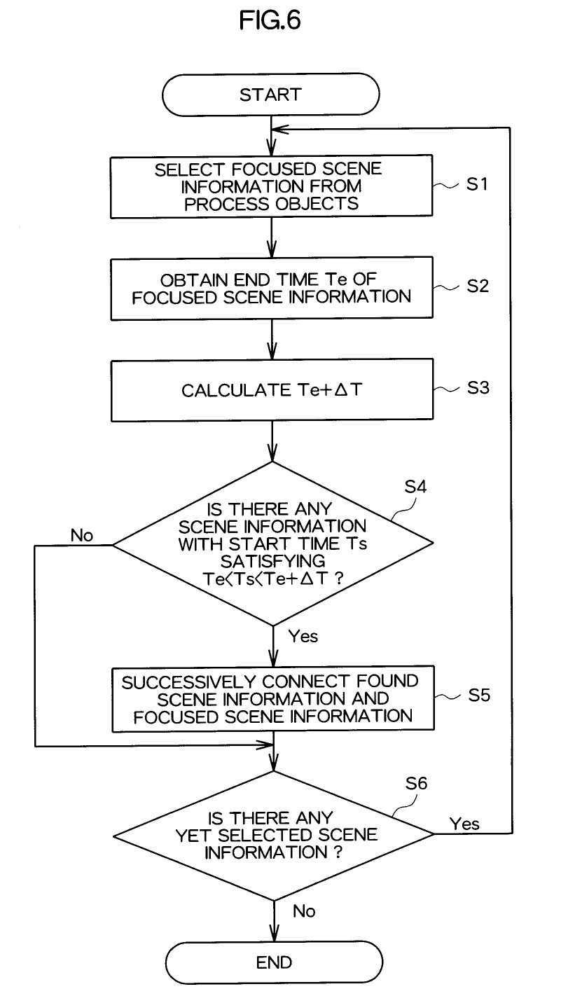

That is, the control section 11 carries out the process shown in FIG. 6 relative to every group of scene information items having a common title identifier contained therein, among the plural scene information items (connection objects) obtained in the search based on the given search condition. That is, while regarding, as process objects, plural scene information items to be connected which all have a common title identifier, one of the process objects is selected as a focused scene information item (S1), and the production end time Te of the selected focused scene information item is obtained (S2). Then, a predetermined threshold ΔT is added to the end time Te (S3). Thereafter, the control section 11 sees whether or not there is any scene information item, among those other than the focused scene information item, which satisfies a predetermined condition that Ts satisfies “Te<Ts<Te+ΔT” with the end time Te obtained at step S2 and “Te+ΔT” calculated at step S3 (S4). In the case where such a scene information item is available, the focused scene information item and the scene information item found at step S4 are connected in the order of the scene numbers (that is, listing in the order of being adjacent) (S5). Thereafter, whether or not there is still a scene information item left in the process objects, which is yet to be selected as a focused scene information, is determined (S6). When no such scene information item is left in the process objects, the process is terminated.

Meanwhile, when it is found at step S6 that there is a scene information item left which is yet to be selected as focused scene information, the process returns to step S1 where one of the scene information items yet to be selected as focused scene information is selected as focused scene information, and the following process is continued.

Returning to step S4, when no scene information item which satisfies the above-described condition is found, the process proceeds to step S6.

As a result of the above-described process, as for the scene information items, among the portions (scene information, here) of the moving data extracted in a search based on a search condition, which are contained in single-item of moving data and deemed to be reproduced at a short interval due to the relationship with respect to a threshold, these scene information items are connected in succession. When the scene information items are successively connected as described above, a statistic operation amount (for example, the largest degree of relevance, the total or average of the degrees of relevance, and so forth) of the degrees of relevance of these scene information items may be obtained based on the degrees of relevance thereof, and the obtained statistic operation amount may be used as the common degree of relevance of the successively connected scene information items.

Then, after the common degree of relevance is determined as described above, the scene information items having the identical degree of relevance are re-arranged in the order of the title identifiers and the scene numbers before being contained in the partial moving data. Then, the re-arranged scene information items are contained in the partial moving data in the order of the degree of relevance. As a result, the scene information items to be successively reproduced as described above are distributed to the terminal device 2 while the order of the respective scene information items to be successively reproduced is preserved.

It should be noted that as for the scene information items to be successively reproduced, information to the effect that the scene information items concerned are to be successively reproduced may be set associated therewith. This information is referred to later in determining the order of connection so that the scene information items to be successively reproduced are successively connected in the order in which these items are to be successive.

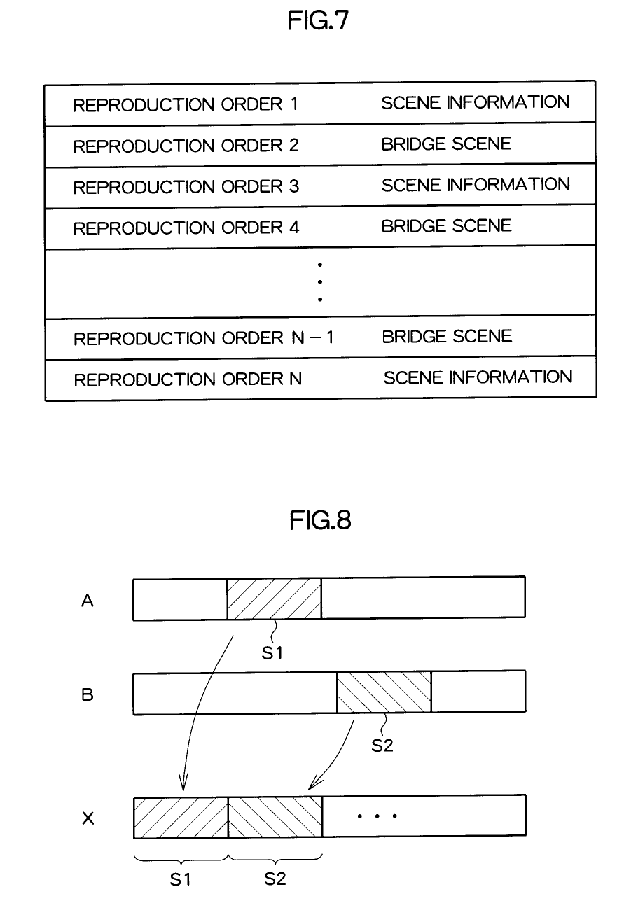

Further, in connecting the scene information items, the moving data processing device 1 may insert a scene identifier (referred to as a bridge information identifier) relevant to predetermined moving data between the respective scene identifiers. Specifically, the motion image of a black screen image to be presented for about one second, for example, may be stored in advance in the storage section 12 as scene information in association with the bridge information identifier, and a scene information item (bridge scene) associated with the bridge information identifier is inserted between the scene information items in the scene information array to be reproduced as partial moving data, as shown in FIG. 7.

In the terminal device 2, as with the scene information array provided as partial moving data, the motion image, audio, and so forth, contained in the scene information items are reproduced in the order of being contained in the array. Therefore, the scene information item relevant to the bridge information identifier is reproduced between the scene information items retrieved in the search, and a black screen image is consequently presented between the scene information items.

It should be noted that alternatively, no scene information item associated with a bridge information identifier may be included between the scene information items which are determined to be reproduced successively in the process of FIG. 6.

Further, it should be noted that although it is described in the above that, as partial moving data, the entireties of the moving data items contained in the scene information items extracted in the search based on a given search condition are successively reproduced, this is not an exclusive example. For example, the control section 11 may receive designation by a user concerning a total period of time Ttotal to spend on reproduction of the partial moving data, then calculate a reproduction period of time to be allocated to each of the scene information items, or τ=Ttotal/N, based on the total number N of the scene information items extracted in the search, and instruct the terminal device 2, when distributing the partial moving data thereto, to reproduce the moving data contained in each of the scene information items, beginning with the head thereof, for a period of time corresponding to the amount τ. Alternatively, the terminal device 2 may calculate the amount τ, and reproduce the moving data of each of the scene information items, beginning with the head thereof, for a period of time corresponding to the amount τ.

In this case, the control section 11 may determine beforehand the minimum unit (the lower limit of τ) τmin of the reproduction time, then calculate the value Nmax which satisfies “Ttotal/Nmax>τmin” with the calculated τ being equal to or smaller than τmin, and selectively remove the (N-Nmax) number of scene information items from the partial moving data so that the Nmax number of scene information items are left in the partial moving data. This selection may be carried out with reference to the information on the degree of reference by removing the (N-Nmax) number of scene information items, for example, from the partial moving data, beginning with the one with a lower degree of relevance, for example.

In the case where more than a predetermined number Np of scene information items are extracted in the search based on a given search condition, the control section 11 of the moving data processing device 1 may produce plural partial moving data items, each containing the Np number of scene information items, and distribute to the terminal device 2.

It should be noted that although it is described in the above that the scene metadata is a character string, or the like, which describes, as a search keyword, the content of the moving data contained in the relevant scene information item, this is not an exclusive example. That is, the scene metadata may contain, instead of or in addition to the character string, a creator name, a lecturer name, classification information, a recording period, an update time and date, a disclosure time and date, reference to associated moving data (link information, such as URL (Uniform Resource Locator), and so forth), reference to an associated document, and so forth.

The terminal device 2 may additionally display such data on the screen when reproducing each of the scene information items contained in the partial moving data.

It should be noted that although it is described in the above that each of the scene information items contains a motion image and audio, this is not an exclusive example, and any other information such as data material (a filmslide, and so forth) may be additionally contained. In this case as well, the terminal device 2 may additionally display such data on the screen when reproducing the partial moving data.

In this exemplary embodiment, as shown in FIG. 8, the moving data processing device 1 extracts a portion (scenes S1 and S2, here) of plural motion image information items A, B, and so forth, which satisfy a designated search condition, and connects the extracted portions to thereby produce partial moving data X. The reproduced partial moving data X is reproduced in the terminal device 2.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A moving data processing device, comprising:
an extraction device that extracts a plurality of portions of a plurality of moving data items, which satisfy a given condition;
a production device that connects the plurality of extracted portions to one another to thereby produce single-item partial moving data, and for a group of a plurality of portions, among the extracted portions, which are to be reproduced in a short period of time comparing with a predetermined threshold, successively connects the plurality of portions constituting the group; and
an output device that outputs the produced partial moving data.

2. A moving data processing device, comprising:
an extraction device that extracts a plurality of portions of a plurality of moving data items, which satisfy a given condition;
a production device that connects the plurality of extracted portions to one another while inserting predetermined information between respective portions to thereby produce single-item partial moving data; and
an output device that outputs the produced partial moving data.

3. A computer readable medium storing a program causing a computer to execute a process comprising:
extracting a plurality of portions of moving data, which satisfy a given condition;
connecting the plurality of extracted portions to one another to thereby produce single-item partial moving data, and for a group of a plurality of portions, among the extracted portions, which are to be reproduced in a short period of time comparing with a predetermined threshold, successively connects the plurality of portions constituting the group; and,
outputting the produced partial moving data.

4. A computer data signal embodied in a carrier wave for enabling a computer to perform a process comprising:
extracting a plurality of portions of moving data, which satisfy a given condition;
connecting the plurality of extracted portions to one another to thereby produce single-item partial moving data, and for a group of a plurality of portions, among the extracted portions, which are to be reproduced in a short period of time comparing with a predetermined threshold, successively connects the plurality of portions constituting the group; and,
outputting the produced partial moving data.

5. A moving data processing method, comprising:
extracting a plurality of portions of moving data, which satisfy a given condition;
connecting the plurality of extracted portions to one another to thereby produce single-item partial moving data, and for a group of a plurality of portions, among the extracted portions, which are to be reproduced in a short period of time comparing with a predetermined threshold, successively connects the plurality of portions constituting the group; and,
outputting the produced partial moving data.
